(19) United States
(12) Patent Application Publication
(10) Pub. No.: US 2026/0228093 A1
(43) Pub. Date: Aug. 6, 2026

(54) RELATIONAL DATABASE MANAGEMENT SYSTEM INCLUDING MONSTER TRANSACTION DETECTION AND HANDLING

(71) Applicant: International Business Machines Corporation, Armonk, NY (US)

(72) Inventors: Fu Fei Xu, Beijing (CN); Su Li Hou, Beijing (CN); Yi Lei Wang, Beijing (CN); Wen Jing Shi, Beijing (CN); Jie Zhang, Beijing (CN); Qian Tao, Beijing (CN); Eric Huang, Taipei City (TW)

(21) Appl. No.: 19/045,674

(22) Filed: Feb. 5, 2025

(51) Int. Cl. G06F 11/14; G06F 11/34; G06F 16/22

(52) U.S. Cl. CPC G06F 11/1471; G06F 11/3419; G06F 16/2282; G06F 2201/80

(57) ABSTRACT

A computer implemented method includes identifying a currently occurring monster transaction in a database using a database management system (DBMS) for the database. The method estimates a time required to end and rollback the currently occurring monster transaction using a learned rollback time estimation process. The learned rollback time estimation process includes applying a rollback time estimation regression model learned on historical monster transactions. The method estimates a time required to complete the currently occurring monster transaction using a learned time to completion estimation process. The learned time to completion estimation process includes applying a completion time estimation regression model learned on historical monster transactions. The method generates a prompt identifying the monster transaction, the estimated time required to end and rollback the currently occurring monster transaction and the estimated time required to complete the currently occurring monster transaction.

### BACKGROUND

The present invention generally relates to relational database management systems (RDBMS), and more specifically, to a RDBMS including a process for identifying and responding to monster transactions.

Database management systems, such as those managing relational databases, monitor and handle database transactions to ensure that there are not conflicts and to ensure that the transactions complete successfully. Certain transactions may run for extremely long periods of time and/or consume extremely large magnitudes of system resources. Such transactions are referred to as monster transactions.

### SUMMARY

Embodiments of the present invention are directed to a computer-implemented method for identifying and responding to monster transactions using a relational database management system. A non-limiting example of the computer-implemented method includes identifying a currently occurring monster transaction in a database using a database management system (DBMS) for the database. The method estimates a time required to end and rollback the currently occurring monster transaction using a learned rollback time estimation process. The learned rollback time estimation process includes applying a rollback time estimation regression model learned on historical monster transactions. The method estimates a time required to complete the currently occurring monster transaction using a learned time to completion estimation process. The learned time to completion estimation process includes applying a completion time estimation regression model learned on historical monster transactions. The method generates a prompt identifying the monster transaction, the estimated time required to end and rollback the currently occurring monster transaction and the estimated time required to complete the currently occurring monster transaction.

Embodiments of the present invention are further directed to a system and a computer program product for the same.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing system for implementing a relational database management system;

FIG. 2 illustrates a system for monster transaction identification and handling;

FIG. 3 illustrates a workflow of the exemplary process for monster transaction identification and handling of FIG. 2;

FIG. 4 illustrates a process for extracting logs for a monster transaction and writing the extracted log to a standalone log file;

FIG. 5 illustrates a process for estimating a rollback time of an ongoing monster transaction; and

FIG. 6 illustrates a process for estimating a completion time for an ongoing monster transaction.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

A computer implemented method includes identifying a currently occurring monster transaction in a database using a database management system (DBMS) for the database. The method estimates a time required to end and rollback the currently occurring monster transaction using a learned rollback time estimation process. The learned rollback time estimation process includes applying a rollback time estimation regression model learned on historical monster transactions. The method estimates a time required to complete the currently occurring monster transaction using a learned time to completion estimation process. The learned time to completion estimation process includes applying a completion time estimation regression model learned on historical monster transactions. The method generates a prompt identifying the monster transaction, the estimated time required to end and rollback the currently occurring monster transaction and the estimated time required to complete the currently occurring monster transaction. The provided prompt allows a database administrator to more easily and quickly determine the best response to a currently occurring monster transaction.

A computer implemented method as in any of the above methods, further including automatically selecting one of ending and rolling back the currently occurring monster transaction and waiting for completion of the currently occurring monster transaction in response to a difference between the estimated time required to end and rollback the currently occurring monster transaction and the estimated time required to complete the currently occurring monster transaction exceeding a predefined magnitude. The automatic selection further improves the operation by automating systems, thereby reducing response times and minimizing cognitive load on operators.

A computer implemented method as in any of the above methods, where a quicker of the estimated time required to end and rollback the currently occurring monster transaction and the estimated time required to complete the currently occurring monster transaction is automatically selected. The automatic selection of the quicker of the times further minimizes the response time and cognitive load requirements.

A computer implemented method as in any of the above methods, wherein the historical monster transactions include historical monster transactions identified in historical transaction logs of the DBMS, and monster transactions identified as the historical monster transactions occurred. The use of historical monster transactions identified in historical monster transaction logs increase the initial accuracy of the learned estimates.

A computer implemented method as in any of the above methods, wherein identifying historical monster transactions in historical transaction logs of the DBMS includes extracted log files of the identified historical monster transactions and saving the extracted log files to a monster transaction log, thereby providing a process and location for identifying relevant historical monster transactions.

A computer implemented method as in any of the above methods, wherein the rollback time estimation model is to regression learned according

$$RollbackTime = \frac{LogTotalSize}{Rollback Efficiency} = \frac{L o g T otalSize}{f ( NumLRPerMb , … , {\sum }_{n = 1}^{x} ( A v {g}_{IoWt [ {TS}_{n} ]} * {δ}_{logNu m [ {T}_{n} ]} ) )} ,$$

$$Rollback Efficiency = \frac{{δ}_{l o g S i z e}}{N} = f ( {x}_{1 ,} {x}_{2 ,} … {x}_{p} ) = f ( NumLRPerMb , {\sum }_{n = 1}^{m} ( {δ}_{IUD [ {T}_{n} ]} ) , {\sum }_{n = 1}^{m} ( {δ}_{S c a n [ {T}_{n} ]} ) , {\sum }_{n = 1}^{m} ( A v {g}_{IoRt [ T {S}_{n} ]} * {δ}_{l o g N u m [ {T}_{n} ]} ) , {\sum }_{n = 1}^{m} ( {Avg}_{IoWt [ {TS}_{n} ]} * {δ}_{logNum [ {T}_{n} ]} ) ) ;$$

and where, LogTotalSize is a total size of the currently operating monster transaction already written to standalone log files, NumLRPerMb is an average number of log records per 1 Mb log, T₁, T₂, . . . Tₓ are tables the currently operating monster transaction has inserted/updated/deleted, TS₁, TS₂, . . . TSₘ are tablespaces where the tables T₁, T₂, . . . Tₓ locate, δ_{IUD[T}_{ₘ}_{]} is a number of rows inserted/updated/deleted to table Tₘ in the database in N seconds, δ_{Sca[T}_{ₘ}_{]} is a number of rows scans taking places in the database for Tₘ in N seconds, Avg_{IoRt[TS}_{ₘ}_{]} is an average time per read input/output for tablespace(s) where stored table Tₘ in N seconds), and Avg_{IoWt[TS}_{ₘ}_{]} is an average time per write input/output for tablespace(s) where stored table Tₘ in N seconds. The particular regressions model provides a detailed, vetted, regression model able to be used to determine rollback time estimation.

A computer implemented method as in any of the above methods, wherein the completion time estimation regression model is learned according to

$${δ}_{IUD} = f ( {y}_{1 ,} {y}_{2 ,} … {y}_{q} ) = f ( {δ}_{N u mLr} , {\sum }_{n = 1}^{m} ( {δ}_{I U D [ {T}_{n} ]} ) , {\sum }_{n = 1}^{m} ( {Avg}_{IoRt [ {TS}_{n} ]} * {δ}_{l o g N u m [ {T}_{n} ]} ) , {\sum }_{n = 1}^{m} ( A v {g}_{IoWt [ T {S}_{n} ]} * {δ}_{l o g N u m [ {T}_{n} ]} ) ) ,$$

$$Processing Efficiency = \frac{{δ}_{IUD}}{N} and$$

$$Time to Complete Transaction = \frac{T otalIUDEstimated - T o t alIUD}{Processing Efficiency} ;$$

and where TotalLogSpaceLeft is a free log space left in the database, δ_{logSizeDb} is a log size written in N seconds by all transactions in the database, δ_{logSize} is a log size written in N seconds by the current monster transaction, δ_{NumLr} is a number of log records written in N seconds, TotalIUDEstimated is an estimated total number of rows inserted/updated/deleted by the monster, TotalIUD is a total number of rows already inserted/updated/deleted by the monster, δ_{IUD} is a number of rows inserted/updated/deleted by the monster in N seconds,

$${δ}_{I U {D}_{d b [ {T}_{m} ]}}$$

is a number of rows inserted/updated/deleted to table Tₘ in the database in N seconds.

$${δ}_{S c a {n}_{d b [ {T}_{m} ]}}$$

is a number of rows scans taking places in the database for Tₘ in N seconds, Avg_{IoRt[TS}_{ₘ}_{]} is an average time per read IO for tablespace(s) where stores table Tₘ in N seconds, and Avg_{IoWt[TS}_{ₘ}_{]} is an average time per write IO for tablespace(s) where stores table Tₘ in N seconds. The particular regressions model provides a detailed, vetted, regression model able to be used to determine a completion time estimation.

A computer implemented method as in any of the above methods, wherein learning the rollback time estimation regression model includes splitting a set of historical monster transactions into a first set and a second set, training the rollback time estimation regression model using the first set, and validating the rollback time estimation regression model using the second set thereby providing for a validation of the learned regression model using preexisting historical data.

A computer implemented method as in any of the above methods, wherein learning the completion time estimation regression model includes splitting a set of historical monster transactions into a first set and a second set, training the rollback time estimation regression model using the first set, and validating the rollback time estimation regression model using the second set thereby providing for a validation of the learned regression model using preexisting historical data.

A non-transitory computer readable medium storing instructions for causing a computer system to perform operations to identify a currently occurring monster transaction in a database using a database management system (DBMS) for the database. The method estimates a time required to end and rollback the currently occurring monster transaction using a learned rollback time estimation process. The learned rollback time estimation process includes applying a rollback time estimation regression model learned on historical monster transactions. The method estimates a time required to complete the currently occurring monster transaction using a learned time to completion estimation process. The learned time to completion estimation process includes applying a completion time estimation regression model learned on historical monster transactions. The method generates a prompt identifying the monster transaction, the estimated time required to end and rollback the currently occurring monster transaction and the estimated time required to complete the currently occurring monster transaction. The provided prompt allows a database administrator to more easily and quickly determine the best response to a currently occurring monster transaction.

The non-transitory computer readable medium of any of the above further storing instructions for causing a computer system to perform operations of automatically selecting one of ending and rolling back the currently occurring monster transaction and waiting for completion of the currently occurring monster transaction in response to a difference between the estimated time required to end and rollback the currently occurring monster transaction and the estimated time required to complete the currently occurring monster transaction exceeding a predefined magnitude. The automatic selection further improves the operation by automating systems, thereby reducing response times and minimizing cognitive load on operators.

The non-transitory computer readable medium of any of the above, where a quicker of the estimated time required to end and rollback the currently occurring monster transaction and the estimated time required to complete the currently occurring monster transaction is automatically selected. The automatic selection of the quicker of the times further minimizes the response time and cognitive load requirements.

The non-transitory computer readable medium of any of the above, wherein the historical monster transactions include historical monster transactions identified in historical transaction logs of the DBMS, and monster transactions identified as the historical monster transactions occurred. The use of historical transaction logs provides a more accurate starting set of information for generating the learned regressions.

The non-transitory computer readable medium of any of the above, wherein identifying historical monster transactions in historical transaction logs of the DBMS includes extracted log files of the identified historical monster transactions and saving the extracted log files to a monster transaction log, thereby providing a particular method for identifying relevant historical monster transactions.

The non-transitory computer readable medium of any of the above, wherein the rollback time estimation regression model is learned according to

$$RollbackTime = \frac{LogTotalSize}{Rollback Efficiency} = \frac{L o g T otalSize}{f ( NumLRPerMb , … , {\sum }_{n = 1}^{x} ( A v {g}_{IoWt [ {TS}_{n} ]} * {δ}_{logNu m [ {T}_{n} ]} ) )} ,$$

$$Rollback Efficiency = \frac{{δ}_{l o g S i z e}}{N} = f ( {x}_{1 ,} {x}_{2 ,} … {x}_{p} ) = f ( NumLRPerMb , {\sum }_{n = 1}^{m} ( {δ}_{IUD [ {T}_{n} ]} ) , {\sum }_{n = 1}^{m} ( {δ}_{S c a n [ {T}_{n} ]} ) , {\sum }_{n = 1}^{m} ( A v {g}_{IoRt [ T {S}_{n} ]} * {δ}_{l o g N u m [ {T}_{n} ]} ) , {\sum }_{n = 1}^{m} ( {Avg}_{IoWt [ {TS}_{n} ]} * {δ}_{logNum [ {T}_{n} ]} ) ) ;$$

and where, LogTotalSize is a total size of the currently operating monster transaction already written to standalone log files, NumLRPerMb is an average number of log records per 1 Mb log, T₁, T₂, . . . Tₓ are tables the currently operating monster transaction has inserted/updated/deleted, TS₁, TS₂, . . . TSₘ are tablespaces where the tables T₁, T₂, . . . Tₓ locate, δ_{IUD[T}_{ₘ}_{]} is a number of rows inserted/updated/deleted to table Tₘ in the database in N seconds, δ_{Scan[T}_{ₘ}_{]} is a number of rows scans taking places in the database for Tₘ in N seconds, Avg_{IoRt[TS}_{ₘ}_{]} is an average time per read input/output for tablespace(s) where stored table Tₘ in N seconds), and Avg_{IoWt[TS}_{ₘ}_{]} is an average time per write input/output for tablespace(s) where stored table Tₘ in N seconds, thereby providing a particular detailed vetted regression model.

The non-transitory computer readable medium of any of the above, wherein the completion time estimation regression model is learned according to

$${δ}_{IUD} = f ( {y}_{1 ,} {y}_{2 ,} … {y}_{q} ) = f ( {δ}_{N u mLr} , {\sum }_{n = 1}^{m} ( {δ}_{I U D [ {T}_{n} ]} ) , {\sum }_{n = 1}^{m} ( {Avg}_{IoRt [ {TS}_{n} ]} * {δ}_{l o g N u m [ {T}_{n} ]} ) , {\sum }_{n = 1}^{m} ( A v {g}_{IoWt [ T {S}_{n} ]} * {δ}_{l o g N u m [ {T}_{n} ]} ) ) ,$$

$$Processing Efficiency = \frac{{δ}_{IUD}}{N} and$$

$$Time to Complete Transaction = \frac{T otalIUDEstimated - T o t alIUD}{Processing Efficiency} ;$$

and where TotalLogSpaceLeft is a free log space left in the database, δ_{logSizeDb} is a log size written in N seconds by all transactions in the database, δ_{logSize} is a log size written in N seconds by the current monster transaction, δ_{NumLr} is a number of log records written in N seconds, TotalIUDEstimated is an estimated total number of rows inserted/updated/deleted by the monster, TotalIUD is a total number of rows already inserted/updated/deleted by the monster, δ_{IUD} is a number of rows inserted/updated/deleted by the monster in N seconds,

$${δ}_{{IUD}_{db [ {T}_{m} ]}}$$

is a number of rows inserted/updated/deleted to table Tₘ in the database in N seconds

$${δ}_{{Scan}_{db [ {T}_{m} ]}}$$

is a number of rows scans taking places in the database for Tₘ in N seconds, Avg_{IoRt[TS}_{ₘ}_{]} is an average time per read IO for tablespace(s) where stores table Tₘ in N seconds, and Avg_{IoWt[TS}_{ₘ}_{]} is an average time per write IO for tablespace(s) where stores table Tₘ in N seconds, thereby providing a more detailed vetted regression model.

The non-transitory computer readable medium of any of the above, wherein learning the rollback time estimation regression model includes splitting a set of historical monster transactions into a first set and a second set, training the rollback time estimation regression model using the first set, and validating the rollback time estimation regression model using the second set, thereby allowing an initial learning set to self validate.

The non-transitory computer readable medium of any of the above, wherein learning the completion time estimation regression model includes splitting a set of historical monster transactions into a first set and a second set, training the rollback time estimation regression model using the first set, and validating the rollback time estimation regression model using the second set, thereby providing a particular methodology for self validation.

A computer system includes at least one client computer having a processor set and a non-transitory memory, the non-transitory memory storing a monster transaction identification and handling module configure to cause the processor set to perform operations of identifying a currently occurring monster transaction in a database using a database management system (DBMS) for the database. The method estimates a time required to end and rollback the currently occurring monster transaction using a learned rollback time estimation process. The learned rollback time estimation process includes applying a rollback time estimation regression model learned on historical monster transactions. The method estimates a time required to complete the currently occurring monster transaction using a learned time to completion estimation process. The learned time to completion estimation process includes applying a completion time estimation regression model learned on historical monster transactions. The method generates a prompt identifying the monster transaction, the estimated time required to end and rollback the currently occurring monster transaction and the estimated time required to complete the currently occurring monster transaction. Thereby providing a computer system for implementing any of the above described processes.

A computer system according to any of the above, wherein the operations further include automatically selecting one of ending and rolling back the currently occurring monster transaction and waiting for completion of the currently occurring monster transaction in response to a difference between the estimated time required to end and rollback the currently occurring monster transaction and the estimated time required to complete the currently occurring monster transaction exceeding a predefined magnitude. The automatic selection further improves the operation by automating systems, thereby reducing response times and minimizing cognitive load on operators.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Computing environment 100 contains an example of an environment for the execution of at least some of the computer code involved in performing the inventive methods, such as monster transaction identification and handling at block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 142, virtual machine set 143, and container set 144.

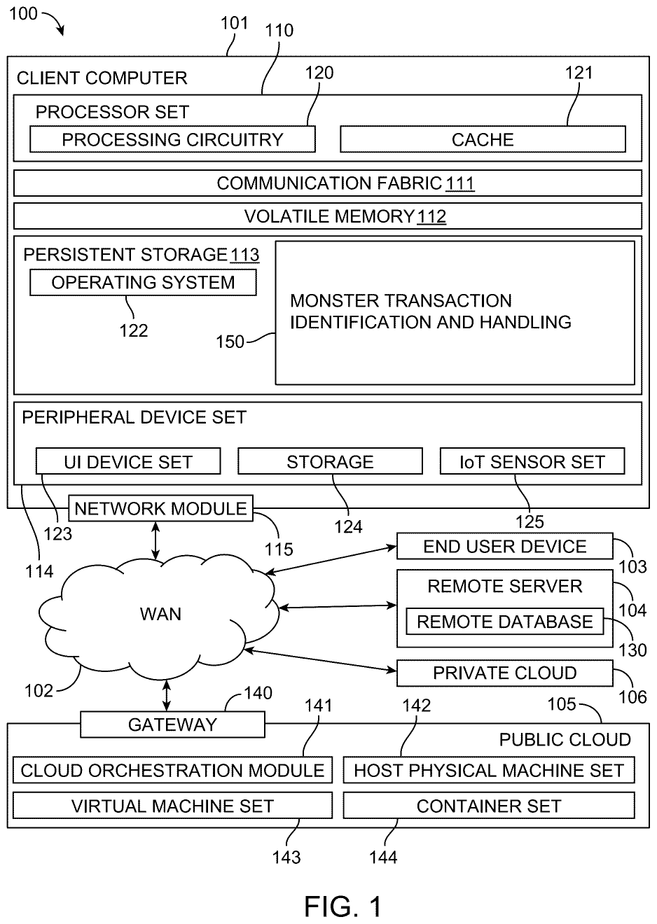

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 141. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

Turning now to an overview of technologies that are more specifically relevant to aspects of the invention, database administrators struggle to best address monster transactions. A monster transaction is a database transaction that runs for a long time and consumes too many system resources. The particular runtime and amount of system resources used in a monster transaction is system dependent and can be determined on a case by case basis. When the monster transaction is running, the responsiveness of the entire system is dragged down. When a database administrator thinks a monster transaction is occurring, the database administrator is faced with a choice between rolling back the monster transaction in order to more quickly put the system performance back on track or allow the monster transaction to continue in case the monster transaction completes quicker than a rollback could be achieved.

When the database administrator chooses to rollback, the response may cost longer time than expected because the rollback process is impacted by at least the log record items that need to be rolled back and the resource conflict that may arise with other online transactions.

When the database administrator chooses killing the database management system followed by a crash recovery after a system recycling, the crash recovery may still take a long time even when data in the table is abandoned because the database management system is required to filter out the log records that are related to the abandoned table.

When the database administrator chooses to allow the monster transaction to continue, the transaction may still have a substantial amount of time remaining, resulting in a substantial slow down of all database functions.

When making this decision, a database administrator would benefit from an understanding of both a time estimation to rollback the transaction and a time estimation to complete the remaining work.

The monster transaction identification and handling process and systems described herein generally address the challenges of handling monster transactions in an efficient way by logging records of monster transactions and writing the logged records into separated standalone log files outside of main log stream. The log records generated by a monster transactions are then automatically separated from the main log file, allowing for more accurate time to completion estimation. The more accurate time to completion estimation from the process and system supports better decisions on whether to continue executing the monster transactions or to force stop & rollback monster transactions.

The processes described herein automatically trains a decision tree model to identify occurring monster transactions based on collected runtime metrics. Records of identified monster transactions are logged into separated standalone log files beyond of main log files, and the records of the monster transactions already written in main log files are extracted into standalone log files asynchronously. Using the logged monster transactions, a regression model is automatically trained to estimate the time required to complete a rollback of a currently running monster transaction based on collected runtime metrics. A second regression model is trained using the collected runtime metrics, and the second regression model estimates the time it would take to complete the currently running monster transaction. Use of the regression models trained on historical monster transactions of the specific RDMBS provides even further improvements over alternative techniques by tailoring the regression models used to provide the estimates to the specific features of the RDMBS being analyzed and allowing for more accurate estimates of rollback time and time to completion.

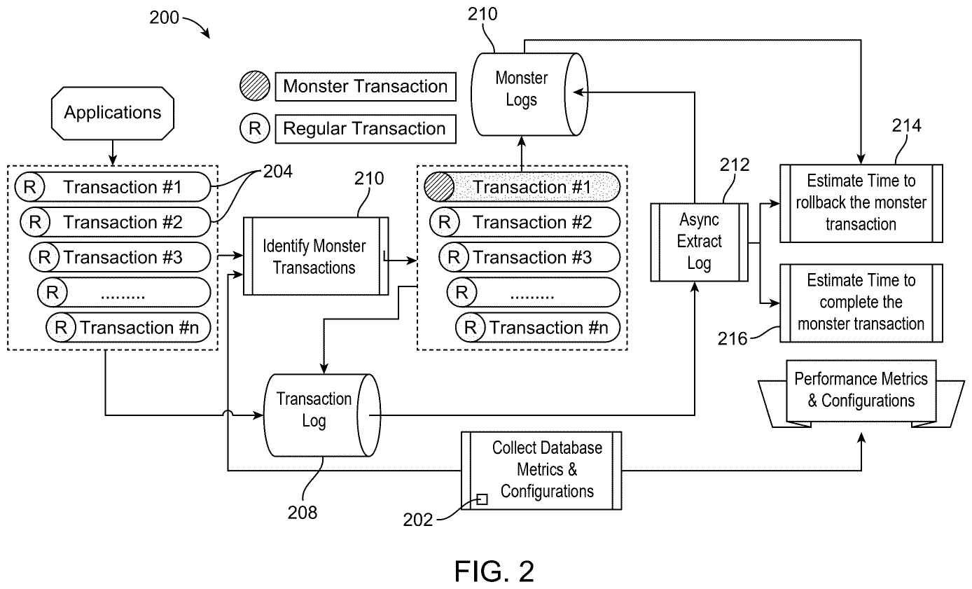

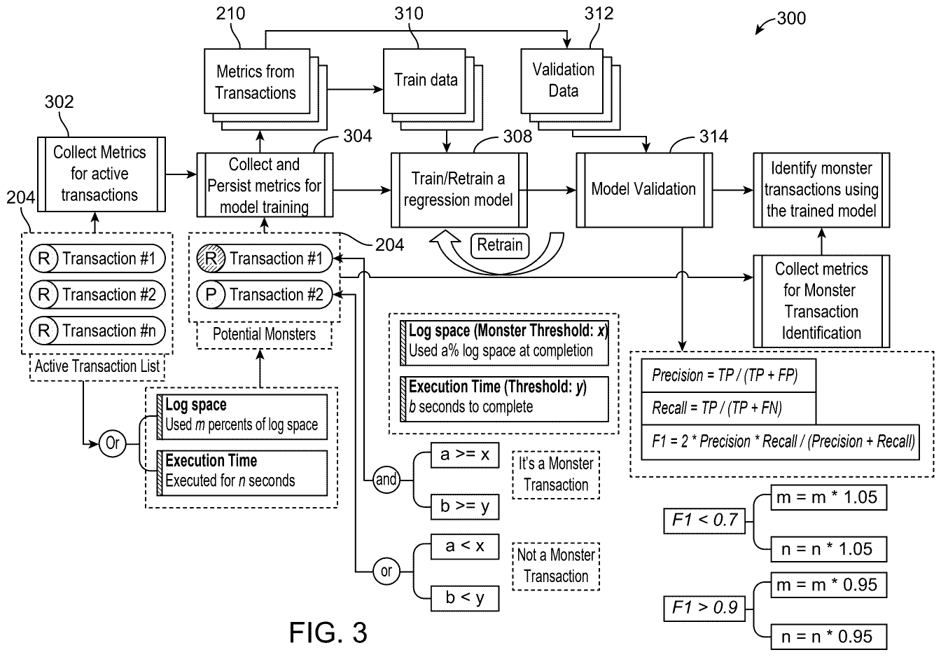

Turning now to a more detailed description of aspects of the present invention, FIG. 2 depicts a general system 200 and FIG. 3 illustrates a workflow 300 of the system 200 of an exemplary process for monster transaction identification and handling according to embodiments of the invention.

The system 200 operates using a set of configurations 202 stored in a memory. The set of configurations 202 define a monster transaction as any transaction that uses ≥X percent of log space and is executed for ≥Y seconds, with the values for X and Y being set by a system designer based on the specifics of the database being analyzed. When an application makes a request that initiates a transaction 204, the workflow 300 starts and metrics regarding the operation of the transaction 204 are collected in a transaction log 208 using a collect metrics for active transactions step 302.

In one particular example, the metrics collected can include P_logUsed (a percent of log space used), T_ExeTime (a transaction execution time), δ_IUD (a number of rows inserted/updated/deleted by the transaction), E_IUD (an estimated total number of rows inserted/updated/deleted by the transaction estimated based on access plan analysis), δ_reads (a number of rows reads by the transaction), E_reads (an estimated total number of rows reads by the transaction (based on an analysis of an access plan), and N_stmt (a number of statements has been executed within the transaction).

The workflow 300 collects and persists the metrics every P seconds for all transactions 204 that either used ≥m percent of the log space or were executed for ≥n seconds, where (X>m, Y>n, m starts as X*0.5, n starts as Y*0.5) in a collect and persists metrics for model training step 304.

When a transaction completes a time to completion and resources used of the transaction are stored (e.g., the transaction used a percents of log space, executed for β seconds), an identify monster transaction routine 210 determines if α≥X and β≥Y. If so, the transaction 204 is identified as a monster transaction and the metrics are stored in a monster transaction log. Otherwise, the transaction 204 is not a monster transaction.

When the transaction 204 is a monster transaction, the collected metrics are stored in a monster transaction log 210. When the transaction 204 is not a monster transaction, the collected metrics are stored in the transaction log 208. In addition, stored historical transactions from prior to initiation of the system 200 that are already stored in the transaction log 208 are analyzed alongside any monster transactions stored in the monster log 210 when generating regression models for future predictions.

The historical monster transactions can be identified in the same manner as currently processing monster transactions using an asynchronous log extraction process 212 to analyze logs of historical operations of the system 200. Once as enough metrics are collected in the monster log 210 from current and historical operations, an automatic model training process (illustrated at training step 308 of workflow 300 of FIG. 3) occurs and the collected metrics are divided into a first set of metrics used for training and a second set of metrics used for validating the trained regressions.

The first set of metrics 310 is used for training regression models in a train regression models step 308 and the second set of metrics 312 is used for validating the trained regressions in a model validation step 314. Once fully trained and validated, the regression models 214, 216 are used proactively to identify monster transactions 204 as they occur and to estimate time to complete the monster transaction (regression model 216) and the time required to rollback the monster transaction (a regression model 214). As more data is collected over time, additional monster transactions are added to the data sets and a retrain process reiterates the training and validation steps.

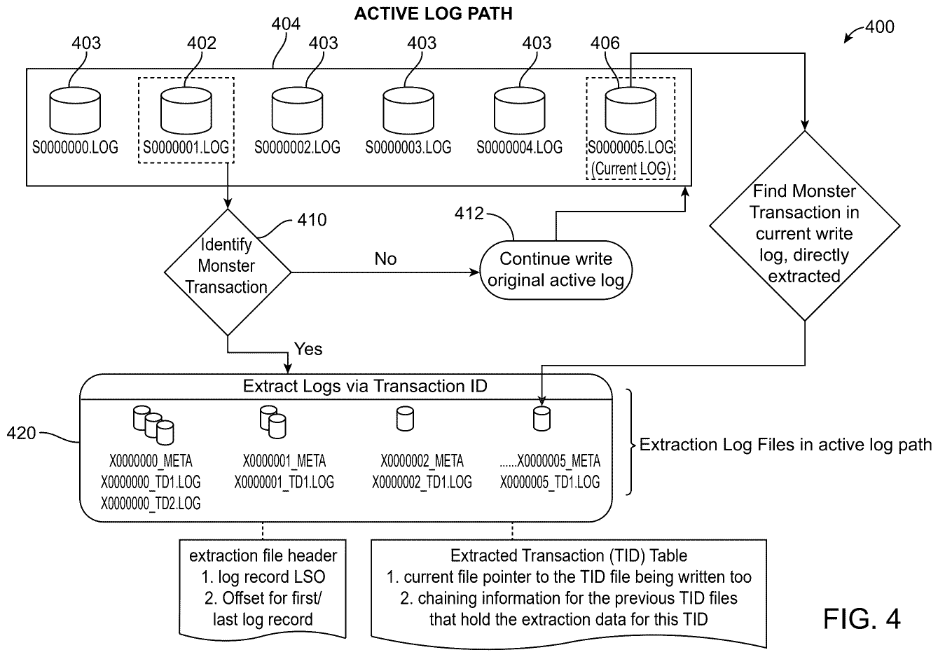

With continued reference to FIGS. 1-3, FIG. 4 illustrates a process 400 for extracting logs for a monster transaction and writing the extracted log to a standalone log file 420.

Initially a database manager identifies a potential monster transaction 402 from an active log path including historical transactions 402, 403 and a currently active transaction 406. In an initial identify historical monster transaction step 410, a potential monster transaction 402 in the set of historical transactions 402, 403 is identified. The log data of the potential monster transaction 402 is analyzed and if the potential monster transaction 402 is not a monster transaction, the process 400 continues with the original active log in a continue to write original active log step 412.

When the potential monster transaction 402 is determined to be a monster transaction, the log data for the monster transaction 402 is extracted from the active log data (the set of active transactions 404) and written to a separate extraction log 420.

In addition, the currently active transaction 406 is identified and analyzed in an analysis step 422. When the currently active transaction is a monster transaction, the corresponding log file is written to the extraction log 420.

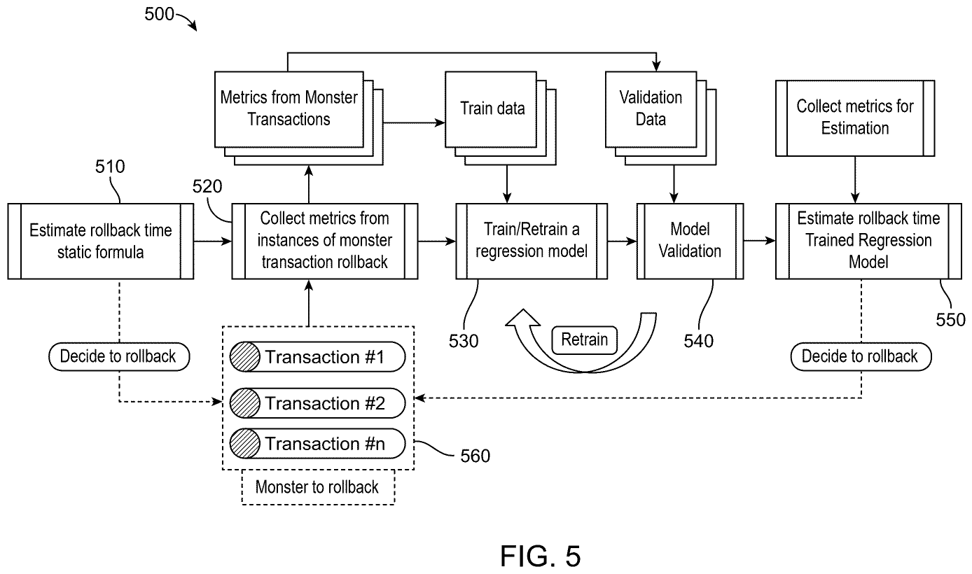

With continued reference to FIGS. 1-4, FIG. 5 illustrates a process 500 for generating an estimation formula and estimating a rollback time of an identified monster transaction. In general, the process 500 initially estimates the rollback time using a predefined static formula in an estimate using static formula step 510.

When a rollback of a monster transaction occurs, metrics of the rollback are collected at a collect metrics step 520. Once enough metrics have been collected, the process 500 trains or retrains a regression model in an automatic training step 530 and the generated model is validated in a model validation step 540. When the model does not validate (e.g., does not accurately predict the rollback time of historical monster transaction rollbacks), the process 500 loops back to the automatic training step 530, and the model is retrained with the new information from the validation step 540.

When the regression model validates correctly, the regression model is used as the trained regression model and estimates rollback time for newly identified potential monster transactions at an estimate rollback time step 550. When the estimated rollback time results in a decision to rollback, the data is collected in a collection process 560, and provided to earlier steps in the process 500 to facilitate future retraining.

In one example, the static regression formula used at the initial step 510 can take the form of:

$$\begin{matrix}TLR = TPLR + TFPAGE + TUPAGE ; and \\ Rollback\_time = \frac{SIZELOG}{TRLOG} + \frac{SIZELOG}{TWLOG} + \frac{SIZELOG}{NumLRPerMb} * TLR ,\end{matrix}$$

Where TLR is the average in milliseconds to undo a log record, TPLR is the average time in milliseconds to shred a log record from a log page, TFPAGE is the average time in milliseconds to retrieve a data page that a log record updated, TUPAGE is the average time in milliseconds to update a data page that a log record updated, TRLOG is the average time in milliseconds to read 1 Mb log, TWLOG is the average time in milliseconds to write 1 Mb log, and SIZELOG is the total size of the monster log files in Mb.

In one example, the metrics collection step 520 collects metrics periodically (e.g., every N seconds) for every rollback of identified monster transactions. The metrics collected may include δ_logSize (log size that rolled back in N seconds), NumLRPerMb (an estimated value determined by evenly collecting sampled log pages from the standalone monster log files, then analyzing the sampled log pages and determining a number of log records contains in the sampled log pages), δ_(IUD [T_m]) (a number of rows inserted/updated/deleted to table T_m in the database in N seconds), δ_(Scan [T_m]) (a number of row scans taking place in the database for T_m in N seconds), Avg_{IoRt[TS}_{ₘ}_{]} (an average time per read IO for tablespace(s) where stores table Tₘ in N seconds), and Avg_{IoWt[TS}_{ₘ}_{]} (an average time per write IO for tablespace(s) where stores table Tₘ in N seconds).

In one example, the collected metrics are used to train the regression mode (step 530) according to:

$$\begin{matrix}Rollback Efficiency = \frac{{δ}_{logSize}}{N} \\ = f ( {x}_{1} , {x}_{2} , … {x}_{p} ) \\ = f ( NumLRPerMb , {\sum }_{n = 1}^{m} ( {δ}_{IUD [ {T}_{n} ]} ) , {\sum }_{n = 1}^{m} ( {δ}_{Scan [ {T}_{n} ]} ) , {\sum }_{n = 1}^{m} ( {Avg}_{IoRt [ {TS}_{n} ]} * {δ}_{logNum [ {T}_{n} ]} ) , {\sum }_{n = 1}^{m} ( {Avg}_{IoWt [ {TS}_{n} ]} * {δ}_{logNum [ {T}_{n} ]} ) ) .\end{matrix}$$

In one example, the metrics used to estimate a rollback time of an ongoing monster transaction in step 550 include

LogTotalSize (the total size of the monster transaction already written to the standalone log files), NumLRPerMb (an average number of log records per 1 Mb log), T₁, T₂, . . . Tₓ (the tables the monster transaction has inserted/updated/deleted retrieved from the access plan)), TS₁, TS₂, . . . TSₘ (tablespaces where the tables T₁, T₂, . . . Tₓ locate, with the tablespaces being retrieved from an access plan)), δ_{IUD[T}_{ₘ}_{]} (a number of rows inserted/updated/deleted to table Tₘ in the database in N seconds), δ_{Scan[T}_{ₘ}_{]} (a number of rows scans taking places in the database for Tₘ in N seconds), Avg_{IoRt[TS}_{ₘ}_{]} (an average time per read IO for tablespace(s) where stores table Tₘ in N seconds), and Avg_{IoWt[TS}_{ₘ}_{]} (an average time per write IO for tablespace(s) where stores table Tₘ in N seconds).

The rollback time is estimated by applying these collected metrics to:

$$\begin{matrix}RollbackTime = \frac{LogTotalSize}{RollbackEfficiency} \\ = \frac{LogTotalSize}{f ( NumLRPerMb , … , {\sum }_{n = 1}^{x} ( {Avg}_{IoWt [ {TS}_{n} ]} * {δ}_{logNum [ {T}_{n} ]} ) )}\end{matrix}$$

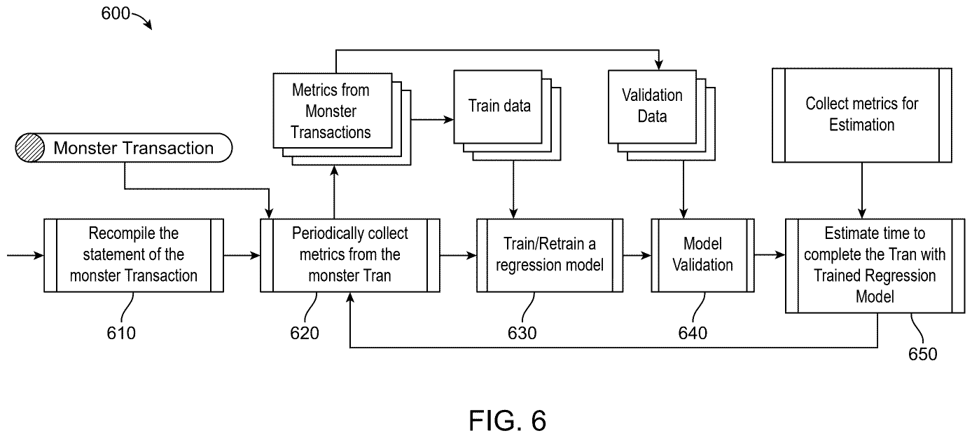

With continued reference to FIGS. 1-5, FIG. 6 illustrates a process 600 for estimating a time required for a currently processing monster transaction to complete operations.

The process 600 initially collects statistics for the tables impacted by the monster transaction in order to ensure that the existing statistics are up to date and explain the table list. The metrics are collected as real time statistics in a memory cache. The collected statistics are used to recompile and regenerate a statement defining the monster transaction in a recompile step 610. Simultaneously with execution of the monster transaction, the process 600 periodically collects and updates the monster transaction metrics in a periodically collect metrics step 620.

Once enough metrics have been collected, the process 600 splits the collected metrics into two sets of metrics and automatically trains a regression model in a train/retrain regression model step 630 using the first set of metrics. The second set of collected metrics are then used to validate the trained model in a validation step 640.

Once a trained and validated model has been generated, the process 600 uses the validated and trained model to estimate a time to completion of a currently running monster transaction at an estimate time for current transaction step 650.

In one example, the periodically collect metrics step 620 collects metrics every period (e.g., every N seconds) and places the metrics in a table. In the example, the collected metrics are TotalLogSpaceLeft (a free log space left in the database), δ_{logSizeDb} (a log size written in N seconds by all transactions in the database), δ_{logSize} (a log size written in N seconds by the current monster transaction), δ_{NumLr} (a number of log records written in N seconds), TotalIUDEstimated (an estimated total number of rows inserted/updated/deleted by the monster), TotalIUD (a total number of rows already inserted/updated/deleted by the monster), δ_{IUD} (a number of rows inserted/updated/deleted by the monster in N seconds, δ_{IUD_db[T}_{ₘ}_{]} (a number of rows inserted/updated/deleted to table Tₘ in the database in N seconds), δ_{Scan_db[T}_{ₘ}_{]} (a number of rows scans taking places in the database for Tₘ in N seconds), Avg_{IoRt[TS}_{ₘ}_{]} (an average time per read IO for tablespace(s) where stores table Tₘ in N seconds), and Avg_{IoWt[TS}_{ₘ}_{]} (an average time per write IO for tablespace(s) where stores table Tₘ in N seconds).

At step 630, the model is trained to estimate an average number of rows insert/update/delete actions (IUD actions) by the monster transaction per N seconds according to:

$${δ}_{IUD} = f ( {y}_{1 ,} {y}_{2 ,} … {y}_{q} ) = f ( {δ}_{NumLr} , {\sum }_{n = 1}^{m} ( {δ}_{IUD [ {T}_{n} ]} ) , {\sum }_{n = 1}^{m} ( {δ}_{Scan [ {T}_{n} ]} ) {\sum }_{n = 1}^{m} ( {Avg}_{IoRt [ {TS}_{n} ]} * {δ}_{logNum [ {T}_{n} ]} ) , {\sum }_{n = 1}^{m} ( {Avg}_{IoWt [ {TS}_{n} ]} * {δ}_{logNum [ {T}_{n} ]} ) )$$

The estimated average number of IUD actions is then used to calculate an estimated time to complete the transaction according to:

$$\begin{matrix}Processing Efficiency = \frac{{δ}_{IUD}}{N} \\ Time to Complete Transaction = \frac{TotalIUDEstimated - TotalIUD}{Processing Efficiency}\end{matrix}$$

Once presented with the estimated time to complete the transaction (output from process 600) and the estimated time to rollback the transaction (output from process 500), the user is able to make an informed decision on whether to allow the monster transaction to proceed, or to rollback the transaction.

In some examples, the RDBMS may include a stored set of default response that can be automatically implemented without requiring a user input. By way of example, the RDBMS may apply a rule automatically selecting a quicker action of the rollback or wait for completion actions in response to a difference between the expected time of each exceeding a predetermined threshold. In such cases, the action is automatically implements and the user is provided with a notification identifying the action.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer implemented method comprising:
identifying a currently occurring monster transaction in a database using a database management system (DBMS) for the database;
estimating a time required to end and rollback the currently occurring monster transaction using a learned rollback time estimation process, the learned rollback time estimation process including applying a rollback time estimation regression model learned on historical monster transactions;
estimating a time required to complete the currently occurring monster transaction using a learned time to completion estimation process, the learned time to completion estimation process including applying a completion time estimation regression model learned on historical monster transactions; and
generating a prompt identifying the monster transaction, the estimated time required to end and rollback the currently occurring monster transaction and the estimated time required to complete the currently occurring monster transaction.

2. The computer implemented method of claim 1, further comprising automatically selecting one of ending and rolling back the currently occurring monster transaction and waiting for completion of the currently occurring monster transaction in response to a difference between the estimated time required to end and rollback the currently occurring monster transaction and the estimated time required to complete the currently occurring monster transaction exceeding a predefined magnitude.

3. The computer implemented method of claim 2, where a quicker of the estimated time required to end and rollback the currently occurring monster transaction and the estimated time required to complete the currently occurring monster transaction is automatically selected.

4. The computer implemented method of claim 1, wherein the historical monster transactions include historical monster transactions identified in historical transaction logs of the DBMS, and monster transactions identified as the historical monster transactions occurred.

5. The computer implemented method of claim 4, wherein identifying historical monster transactions in historical transaction logs of the DBMS includes extracted log files of the identified historical monster transactions and saving the extracted log files to a monster transaction log.

6. The computer implemented method of claim 1, wherein the rollback time estimation regression model is learned according to
$$\begin{matrix}RollbackTime = \frac{LogTotalSize}{Rollback Efficiency} = \frac{LogTotalSize}{f ( NumLRPerMb , … , {\sum }_{n = 1}^{x} ( {Avg}_{IoWt [ {TS}_{n} ]} * {δ}_{logNum [ {T}_{n} ]} ) )} , \\ Rollback Efficiency = \frac{{δ}_{logSize}}{N} = f ( {x}_{1 ,} {x}_{2 ,} … {x}_{p} ) = f ( NumLRPerMb , {\sum }_{n = 1}^{m} ( {δ}_{IUD [ {T}_{n} ]} ) , {\sum }_{n = 1}^{m} ( {δ}_{Scan [ {T}_{n} ]} ) , {\sum }_{n = 1}^{m} ( {Avg}_{IoRt [ {TS}_{n} ]} * {δ}_{logNum [ {T}_{n} ]} ) , {\sum }_{n = 1}^{m} ( {Avg}_{IoWt [ {Ts}_{n} ]} * {δ}_{logNum [ {T}_{n} ]} ) ) ;\end{matrix}$$
and
where, LogTotalSize is a total size of the currently operating monster transaction already written to standalone log files, NumLRPerMb is an average number of log records per 1 Mb log, T₁, T₂, . . . Tₓ are tables the currently operating monster transaction has inserted/updated/deleted, TS₁, TS₂, . . . TSₘ are tablespaces where the tables T₁, T₂, . . . Tₓ locate, δ_{IUD[T}_{ₘ}_{]} is a number of rows inserted/updated/deleted to table Tₘ in the database in N seconds, δ_{Sca[T}_{ₘ}_{]} is a number of rows scans taking places in the database for Tₘ in N seconds, Avg_{IoRt[TS}_{ₘ}_{]} is an average time per read input/output for tablespace(s) where stored table Tₘ in N seconds), and Avg_{IoWt[TS}_{ₘ}_{]} is an average time per write input/output for tablespace(s) where stored table Tₘ in N seconds.

7. The computer implemented method of claim 1, wherein the completion time estimation regression model is learned according to
$${δ}_{IUD} = f ( {y}_{1 ,} {y}_{2 ,} … {y}_{q} ) = f ( {δ}_{NumLr} , {\sum }_{n = 1}^{m} ( {δ}_{IUD [ {T}_{n} ]} ) , {\sum }_{n = 1}^{m} ( {δ}_{Scan [ {T}_{n} ]} ) {\sum }_{n = 1}^{m} ( {Avg}_{IoRt [ {TS}_{n} ]} * {δ}_{logNum [ {T}_{n} ]} ) , {\sum }_{n = 1}^{m} ( {Avg}_{IoWt [ {TS}_{n} ]} * {δ}_{logNum [ {T}_{n} ]} ) ) , Processing Efficiency = \frac{{δ}_{IUD}}{N} and Time to complete Transaction = \frac{TotalIUDEstimated - TotalIUD}{Processing Efficiency} ;$$
and
where TotalLogSpaceLeft is a free log space left in the database, δ_{logSizeDb} is a log size written in N seconds by all transactions in the database, δ_{logSize} is a log size written in N seconds by the current monster transaction, δ_{NumLr} is a number of log records written in N seconds, TotalIUDEstimated is an estimated total number of rows inserted/updated/deleted by the monster, TotalIUD is a total number of rows already inserted/updated/deleted by the monster, δ_{IUD} is a number of rows inserted/updated/deleted by the monster in N seconds,
$${δ}_{{IUD}_{db [ {T}_{m} ]}}$$
is a number of rows inserted/updated/deleted to table Tₘ in the database in N seconds,
$${δ}_{{Scan}_{db [ {T}_{m} ]}}$$
is a number of rows scans taking places in the database for Tₘ in N seconds, Avg_{IoRt[TS}_{ₘ}_{]} is an average time per read IO for tablespace(s) where stores table Tₘ in N seconds, and Avg_{IoWt[TS}_{ₘ}_{]} is an average time per write IO for tablespace(s) where stores table Tₘ in N seconds.

8. The computer implemented method of claim 1, wherein learning the rollback time estimation regression model includes splitting a set of historical monster transactions into a first set and a second set, training the rollback time estimation regression model using the first set, and validating the rollback time estimation regression model using the second set.

9. The computer implemented method of claim 1, wherein learning the completion time estimation regression model includes splitting a set of historical monster transactions into a first set and a second set, training the rollback time estimation model using the second set.

10. A non-transitory computer readable medium storing instructions for causing a computer system to perform operations of:
identifying a currently occurring monster transaction in a database using a database management system (DBMS) for the database;
estimating a time required to end and rollback the currently occurring monster transaction using a learned rollback time estimation process, the learned rollback time estimation process including applying a rollback time estimation regression model learned on historical monster transactions;
estimating a time required to complete the currently occurring monster transaction using a learned time to completion estimation process, the learned time to completion estimation process including applying a completion time estimation regression model learned on historical monster transactions; and
generating a prompt identifying the monster transaction, the estimated time required to end and rollback the currently occurring monster transaction and the estimated time required to complete the currently occurring monster transaction.

11. The non-transitory computer readable medium of claim 10, further comprising automatically selecting one of ending and rolling back the currently occurring monster transaction and waiting for completion of the currently occurring monster transaction in response to a difference between the estimated time required to end and rollback the currently occurring monster transaction and the estimated time required to complete the currently occurring monster transaction exceeding a predefined magnitude.

12. The non-transitory computer readable medium of claim 11, where a quicker of the estimated time required to end and rollback the currently occurring monster transaction and the estimated time required to complete the currently occurring monster transaction is automatically selected.

13. The non-transitory computer readable medium of claim 10, wherein the historical monster transactions include historical monster transactions identified in historical transaction logs of the DBMS, and monster transactions identified as the historical monster transactions occurred.

14. The non-transitory computer readable medium of claim 13, wherein identifying historical monster transactions in historical transaction logs of the DBMS includes extracted log files of the identified historical monster transactions and saving the extracted log files to a monster transaction log.

15. The non-transitory computer readable medium of claim 10, wherein the rollback time estimation regression model is learned according to
$$\begin{matrix}RollbackTime = \frac{LogTotalSize}{Rollback Efficiency} = \frac{LogTotalSize}{f ( NumLRPerMb , … , {\sum }_{n = 1}^{x} ( {Avg}_{IoWt [ {TS}_{n} ]} * {δ}_{logNum [ {T}_{n} ]} ) )} , \\ Rollback Efficiency = \frac{{δ}_{logSize}}{N} = f ( {x}_{1 ,} {x}_{2 ,} … {x}_{p} ) = f ( NumLRPerMb , {\sum }_{n = 1}^{m} ( {δ}_{IUD [ {T}_{n} ]} ) , {\sum }_{n = 1}^{m} ( {δ}_{Scan [ {T}_{n} ]} ) , {\sum }_{n = 1}^{m} ( {Avg}_{IoRt [ {TS}_{n} ]} * {δ}_{logNum [ {T}_{n} ]} ) , {\sum }_{n = 1}^{m} ( {Avg}_{IoWt [ {Ts}_{n} ]} * {δ}_{logNum [ {T}_{n} ]} ) ) ;\end{matrix}$$
and
where, LogTotalSize is a total size of the currently operating monster transaction already written to standalone log files, NumLRPerMb is an average number of log records per 1 Mb log, T₁, T₂, . . . Tₓ are tables the currently operating monster transaction has inserted/updated/deleted, TS₁, TS₂, . . . TSₘ are tablespaces where the tables T₁, T₂, . . . Tₓ locate, δ_{IUD[T}_{ₘ}_{]} is a number of rows inserted/updated/deleted to table Tₘ in the database in N seconds, δ_{Scan[T}_{ₘ}_{]} is a number of rows scans taking places in the database for Tₘ in N seconds, Avg_{IoRt[TS}_{ₘ}_{]} is an average time per read input/output for tablespace(s) where stored table Tₘ in N seconds), and Avg_{IoWt[TS}_{ₘ}_{]} is an average time per write input/output for tablespace(s) where stored table Tₘ in N seconds.

16. The non-transitory computer readable medium of claim 10, wherein the completion time estimation regression model is learned according to
$${δ}_{IUD} = f ( {y}_{1 ,} {y}_{2 ,} … {y}_{q} ) = f ( {δ}_{NumLr} , {\sum }_{n = 1}^{m} ( {δ}_{IUD [ {T}_{n} ]} ) , {\sum }_{n = 1}^{m} ( {δ}_{Scan [ {T}_{n} ]} ) {\sum }_{n = 1}^{m} ( {Avg}_{IoRt [ {TS}_{n} ]} * {δ}_{logNum [ {T}_{n} ]} ) , {\sum }_{n = 1}^{m} ( {Avg}_{IoWt [ {TS}_{n} ]} * {δ}_{logNum [ {T}_{n} ]} ) ) , Processing Efficiency = \frac{{δ}_{IUD}}{N} and Time to complete Transaction = \frac{TotalIUDEstimated - TotalIUD}{Processing Efficiency} ;$$
and
where TotalLogSpaceLeft is a free log space left in the database, δ_{logSizeDb} is a log size written in N seconds by all transactions in the database, δ_{logSize} is a log size written in N seconds by the current monster transaction, δ_{NumLr} is a number of log records written in N seconds, TotalIUDEstimated is an estimated total number of rows inserted/updated/deleted by the monster, TotalIUD is a total number of rows already inserted/updated/deleted by the monster, δ_{IUD} is a number of rows inserted/updated/deleted by the monster in N seconds,
$${δ}_{{IUD}_{db [ {T}_{m} ]}}$$
is a number of rows inserted/updated/deleted to table Tₘ in the database in N seconds,
$${δ}_{{Scan}_{db [ {T}_{m} ]}}$$
is a number of rows scans taking places in the database for Tₘ in N seconds, Avg_{IoRt[TS}_{ₘ}_{]} is an average time per read IO for tablespace(s) where stores table Tₘ in N seconds, and Avg_{IoWt[TS}_{ₘ}_{]} is an average time per write IO for tablespace(s) where stores table Tₘ in N seconds.

17. The non-transitory computer readable medium of claim 10, wherein learning the rollback time estimation regression model includes splitting a set of historical monster transactions into a first set and a second set, training the rollback time estimation regression model using the first set, and validating the rollback time estimation regression model using the second set.

18. The non-transitory computer readable medium of claim 10, wherein learning the completion time estimation regression model includes splitting a set of historical monster transactions into a first set and a second set, training the rollback time estimation model using the second set.

19. A computer system comprising:
at least one client computer having a processor set and a non-transitory memory, the non-transitory memory storing a monster transaction identification and handling module configure to cause the processor set to perform operations of:
identifying a currently occurring monster transaction in a database using a database management system (DBMS) for the database;
estimating a time required to end and rollback the currently occurring monster transaction using a learned rollback time estimation process, the learned rollback time estimation process including applying a rollback time estimation regression model learned on historical monster transactions;
estimating a time required to complete the currently occurring monster transaction using a learned time to completion estimation process, the learned time to completion estimation process including applying a completion time estimation regression model learned on historical monster transactions; and
generating a prompt identifying the monster transaction, the estimated time required to end and rollback the currently occurring monster transaction and the estimated time required to complete the currently occurring monster transaction.

20. The computer system of claim 19, wherein the operations further include automatically selecting one of ending and rolling back the currently occurring monster transaction and waiting for completion of the currently occurring monster transaction in response to a difference between the estimated time required to end and rollback the currently occurring monster transaction and the estimated time required to complete the currently occurring monster transaction exceeding a predefined magnitude.
